(19) United States
(12) Patent Application Publication
(10) Pub. No.: US 2025/0333271 A1
(43) Pub. Date: Oct. 30, 2025

(54) ELEVATOR DOOR COUPLER SYSTEM

(71) Applicant: Otis Elevator Company, Farmington, CT (US)

(72) Inventor: Sébastien Fougeron, Gien (FR)

(21) Appl. No.: 19/175,382

(22) Filed: Apr. 10, 2025

(30) Foreign Application Priority Data
Apr. 24, 2024 (EP) 24305631.4

(51) Int. Cl. B66B 13/12

(52) U.S. Cl. CPC B66B 13/12

(57) ABSTRACT

An elevator door coupler system (1) includes a door hanger (12), for connection to an elevator car door (2) and at least one roller (14a, 14b), mounted to the door hanger (12). The door hanger (12) comprises a first elongate opening (54a, 54b, 60a, 60b, 62a, 62b, 64a, 64b, 66a, 66b, 68a, 68b, 70a, 70b) for fixedly mounting a coupling assembly (16) arranged to engage a landing door so as to actuate movement of the landing door together with movement of the elevator car door (2), such that a position of the coupling assembly (16) relative to the door hanger (12) is adjustable by mounting the coupling assembly (16) at a different position within the first elongate opening (54a, 54b, 60a, 60b, 62a, 62b, 64a, 64b, 66a, 66b, 68a, 68b, 70a, 70b).

### FOREIGN PRIORITY

This application claims priority to European Patent Application No. 24305631.4, filed Apr. 24, 2024, and all the benefits accruing therefrom under 35 U.S.C. § 119, the contents of which in its entirety are herein incorporated by reference.

### TECHNICAL FIELD OF INVENTION

This disclosure relates to an elevator door coupler system and a method of installing an elevator door coupler system into an elevator system.

### BACKGROUND OF THE INVENTION

It is known to provide an elevator door coupler system to both enable driving of elevator car doors between an open and a closed position, and also to couple with a corresponding set of landing doors, to open and close the landing doors as the elevator car doors are opened or closed.

It is known to install landing doors when initially installing an elevator system, and therefore to install landing doors which are compatible with the installed elevator, and in particular with the elevator door coupler system.

However, if an elevator is installed in an existing system (e.g. replacing an existing elevator with a more modern system), the landing doors of that system will be one of many different types of landing doors with different landing door roller placement. In order to accommodate these different arrangements, it is known for elevator system suppliers to manufacture multiple different elevator door coupler systems, to select between, and to install in a given elevator system the elevator door coupler system of those manufactured options which is most appropriate. However, it is time consuming and costly to produce these many different varieties of elevator door coupler system. The present disclosure seeks to provide an improved elevator door coupler system.

### SUMMARY OF THE INVENTION

According to a first aspect of this disclosure there is provided an elevator door coupler system comprising: a door hanger, for connection to an elevator car door; and at least one roller, mounted to the door hanger; wherein the door hanger comprises a first elongate opening for fixedly mounting a coupling assembly arranged to engage a landing door so as to actuate movement of the landing door together with movement of the elevator car door, such that a position of the coupling assembly relative to the door hanger is adjustable by mounting the coupling assembly at a different position within the first elongate opening.

According to a second aspect of the present disclosure there is provided a method of installing an elevator door coupler system into an elevator system, the method comprising: mounting at least one roller to a door hanger, the door hanger suitable for connection to an elevator car door; and mounting a coupling assembly to the door hanger, the mounting comprising selecting a suitable position for the coupling assembly relative to the door hanger by selecting a suitable mounting position within a first elongate opening of the door hanger and fixedly mounting the coupling assembly to the door hanger at the selected position.

By providing a first elongate opening in the door hanger, an elevator door coupler is provided in which the coupling assembly may be mounted at a plurality of positions, i.e. across a (continuous) range of positions. This provides versatility in the mounting position of the coupling assembly which allows the elevator door coupler system to be adapted to be compatible with different landing door systems (i.e. with several, many or even all landing door systems existing in elevator systems or available for elevator systems). Providing the first elongate specifically on the door hanger (i.e. the part arranged to move on the at least one roller to move the elevator car door), e.g. rather than on a part of coupling assembly, is advantageous because it conveniently makes use of existing space in the area of the door hanger without needing to significantly increase the area, height or width of the door hanger. It also avoids needing to make components of the coupling assembly significantly larger in order to accommodate one (or more) elongate openings for mounting, and also avoids a risk of reducing strength of those critical components by removing additional material from them. Providing at least one elongate opening in the door hanger also enables easier mounting of the coupling assembly at the desired position (i.e. the correct position for a given landing door system of a particular elevator installation). The Applicant has appreciated that a single hanger design may be capable of accommodating differing dimensions of many (or even all) landing doors which may be present in a building containing a given elevator installation. Providing such a door hanger avoids a need to produce different door hangers, or even entire elevator door coupler systems, unique to one or a few landing door designs.

Such adaptation of the mounting position of the coupling assembly may take place in the factory, during initial construction of the elevator door coupler system, or it may take place during installation of the elevator door coupler system in an elevator system, or the adaptation may be carried out partly during initial construction and partly during later installation. For example, during construction, the coupling assembly may be mounted through the first elongate opening (or whichever opening, discussed further below, is determined to be most appropriate). Then, during installation at the elevator system the installer may set the precise position within the elongate opening (i.e. along the elongate direction) at which to fix the coupling assembly. Thus, in some examples, the method comprises adjusting the coupling assembly to a suitable mounting position by moving a fixing means of the coupling assembly within the first elongate opening.

The door hanger is connected, in use, to an elevator car door of an elevator system. It also has rollers mounted to it. It will be understood that in use the hanger is able to move on the at least one roller, and that movement of the door hanger on the at least one roller moves the elevator car door. It will be understood that the coupling assembly, when mounted to the door hanger, is arranged to move together with the door hanger and therefore to actuate movement of the landing door together with movement of the door hanger (which in use moves the elevator car door).

The first elongate opening is for fixedly mounting a coupling assembly to the door hanger. By fixedly mounting it will be understood that once mounted (i.e. in use) the mounting position of the coupling assembly is fixed. Thus, the mounting point does not move relative to the door hanger in use (although other parts of the coupling assembly may of course still move relative to the door hanger). Thus, although the mounting position of the coupling assembly to the door hanger is adjustable (i.e. selectable), after mounting it is fixed (i.e. not variable), such that the coupling assembly (i.e. a fixing means thereof) cannot (or at least should not) move once the coupling assembly has been fixedly mounted in the selected mounting position (i.e. in use).

The first opening is elongate (i.e. elongate along a first direction). By this it will be understood that it is longer along a length (or elongate) direction than it is perpendicular to this direction (i.e. across its width). The first elongate opening may have a width, perpendicular to its length direction, substantially equal to a width of a fixing means (e.g. a screw or nut) used to secure the coupling assembly to the door hanger. It thus has a length along its elongate direction longer than this width, optionally several times (or more) longer, i.e. such that the fixing means can be mounted at different positions along the elongate direction of the first elongate opening, but only one position (e.g. height) perpendicular to this direction (for a given opening).

It will be understood that the at least one roller enables movement of the door hanger along a movement direction (e.g. a lateral or horizontal direction), so as to enable, in use, movement of the elevator car door parallel to the movement direction (e.g. the lateral or horizontal direction).

In some examples, the first elongate opening is elongate along a direction (substantially) parallel to the movement direction. Thus, the position of the coupling assembly along the movement direction (i.e. its lateral position) is adjustable. The position of the coupling assembly may be adjustable along the horizontal direction (i.e. relative to the elevator car).

In some examples, the first elongate opening has a length (i.e. along the elongate direction) of at least 5 cm, optionally at least 10 cm, further optionally at least 15 cm. This allows a relatively wide range of adjustment (e.g. along the lateral direction), improving adaptability of the elevator door coupler system.

In some examples, the door hanger further comprises a second elongate opening, spaced apart from the first elongate opening along a direction perpendicular to the first direction (e.g. to the movement direction). The second elongate opening may also be elongate along the first (e.g. movement) direction, i.e. it may extend parallel to the first elongate opening. This allows the possibility of mounting the coupling assembly at two different heights relative to the door hanger (i.e. at two different distances along a second (e.g. vertical) direction, perpendicular to the first/movement direction). Thus, the position of the coupling assembly may be adjustable both along a height direction (perpendicular to the first direction) by selecting the elongate opening for mounting (e.g. out of the first and second elongate openings, and optionally one or more further openings) and also adjustable along the first direction by selecting a mounting position along the length of the elongate opening. A second elongate opening at a different height also allows the possibility of more securely and stably mounting the coupling assembly by mounting it at (e.g. through) both the first elongate opening and the second elongate opening. It will be appreciated that whether or not mounting through both openings it possible may also depend on the structure of one or more parts of the coupling assembly, e.g. whether it is provided with multiple mounting openings.

In some examples, the first elongate opening and the second elongate opening span different distance ranges along the first direction i.e. they span non-identical lengths along the first (e.g. movement) direction. However, they may cover overlapping parts along the first direction. This difference in distance ranges along the first (movement) direction provides greater versatility in mounting position since both different heights and different lateral positions are possible. Furthermore, the positioning of the elongate openings may be chosen to take account of the different lateral positions (along the first direction) being preferred for different mounting heights. The first elongate opening and the second elongate opening may be the same length (i.e. but not exactly vertically one above the other) or may be different lengths.

In some examples, door hanger comprises at least three elongate openings (e.g. a first, second and third), optionally at least six elongate openings, each positioned at a different height perpendicular to the first direction (i.e. their elongate direction). This allows mounting of the coupling assembly at a number of different heights.

In some examples, the method further comprises selecting a suitable one (or more) of the first and second (optionally three or more) elongate openings for mounting the coupling assembly, based on a desired mounting height of the coupling assembly, perpendicular to the first direction. The method may further comprise selecting a (lateral) mounting position within the selected elongate opening for mounting the coupling assembly. The first stage—selecting the mounting height by selecting the opening(s) for mounting—may take place in the factory during construction, and the second stage—selecting and fixing the lateral position within the elongate opening—may take place at an elevator system during installation.

In some examples, the first elongate opening and the second elongate opening span the same distance range along the first (e.g. movement) direction (i.e. they are vertically one above the other, or in other words they are the same length along the first direction and aligned relative to this direction). In some examples, the coupling assembly is arranged to be fixedly mounted to the door hanger through both the first elongate opening and the second elongate opening simultaneously. By being simultaneously fixedly mounted through both the first and second elongate openings it is meant that when the coupling assembly is fixed in place, ready for use, it is fixed to the door hanger through both of these openings. It will be appreciated that this does not require that the mounting action itself is carried out simultaneously. Mounting at two positions in this way improves the stability of mounting of the coupling assembly. Thus, in some examples, the method further comprises fixedly mounting the coupling assembly to the door hanger at the selected position by connecting the coupling assembly to the door hanger at (i.e. through) two elongate openings, e.g. both the first elongate opening and the second elongate opening.

In some examples, the first elongate opening and the second elongate opening provide a first mounting opening pair, i.e. which in use are used together to mount the coupling assembly. The first elongate opening and the second elongate opening may be separated along a direction perpendicular to the first direction by a first separation distance.

The elevator door coupler system may further comprise a second mounting opening pair, comprising a third elongate opening and a fourth elongate opening. The fourth elongate opening may be spaced apart from the third elongate opening along a direction perpendicular to the first (e.g. movement) direction. The third elongate opening and the fourth elongate opening may span the same distance range along the first direction.

The third elongate opening and/or the fourth elongate opening may be spaced apart from (each of) the first elongate opening and/or the second elongate opening along a direction perpendicular to the first direction (i.e. all four openings are at different heights). Thus, the door hanger may comprise a first pair of elongate openings, vertically one above each other, at a first lateral position and a first and second respective height, and a second pair of elongate openings, vertically one above each other, at a second, different lateral position and at a third and fourth respective height, different to the first and second heights.

The third elongate opening and the fourth elongate opening may be separated along a direction perpendicular to the first direction by a second separation distance. The second separation distance may be equal to the first separation distance. Thus, pairs of spaced apart elongate openings may be provided, separated by the same separation distance, so that each pair of openings is able to accommodate mounting of the coupling assembly, i.e. to accommodate a fixed separation between the two mounting positions.

The elevator door coupler system may comprise more than two such mounting opening pairs, e.g. at least three, optionally at least five, further optionally six. All of the pairs of mounting openings may be positioned at different heights (e.g. with their centre, equidistant between the openings, at different heights), and/or at different lateral positions (i.e. with their horizontal centres at different positions) and/or spanning different lateral ranges.

In some examples, the door hanger further comprises a roller mounting hole, wherein the at least one roller (i.e. a roller) is mounted to the door hanger through the roller mounting hole (i.e. via a fixing means extending through the roller mounting hole). In some examples, the elevator door coupler system comprises a first roller and a second roller (i.e. at least two rollers). The door hanger may further comprise a second roller mounting hole, wherein the second roller is mounted to the door hanger through the second roller mounting hole.

In some examples, the elevator door coupler system further comprises at least one (optionally two) elevator car door mounting holes, for connecting the door hanger to the elevator car door. The elevator car door mounting hole(s) may be aligned below the roller mounting hole(s), i.e. aligned on an axis perpendicular to the first direction.

In some examples, the elevator door coupler system further comprises a deterrent assembly for preventing, in use, the opening of the elevator car door when the coupling assembly is not engaged with the landing door. This effect may be achieved in any suitable manner (e.g. in any known manner) by the deterrent assembly. For example, the deterrent assembly may be held in an upward position when the elevator car door is closed. Friction or pressure due to contact of a landing door roller on part of the deterrent assembly may hold the deterrent assembly in this upward position during door opening, provided that the landing door is positioned correctly relative to the elevator door coupler system. By contrast, when no landing door roller contacts the deterrent assembly (e.g. is pressed onto the deterrent assembly by part of the coupler assembly), the deterrent assembly will drop from the upward position to a lower position as door opening begins, causing it to engage with a locking member, e.g. a protrusion of the deterrent assembly may drop into a slot of a latch mechanism. The deterrent assembly may comprise a deterrent stop (e.g. a deterrent screw). This may be arranged to determine the lower position of the deterrent assembly, e.g. to limit how far the deterrent assembly (or part of it) drops.

In some examples, the door hanger further comprises a deterrent-assembly-mounting opening, for fixedly mounting the deterrent assembly to the door hanger, wherein the deterrent-assembly-mounting opening is elongate, such that a position of the deterrent assembly relative to the door hanger is adjustable by mounting the deterrent assembly at a different position within the deterrent-assembly-mounting opening. The deterrent-assembly-mounting opening may be elongate along the first direction (i.e. parallel to the first elongate opening), optionally along the movement direction (i.e. along the horizontal or lateral direction). The door hanger may comprise a first deterrent-assembly-mounting opening and a second deterrent-assembly-mounting opening (which may each have the features set out above). Both may span the same distance range along the first direction, i.e. be the same length and be aligned relative to the first direction. Thus, the deterrent assembly may be mounted through both of the deterrent-assembly-mounting openings.

In some examples, the method further comprises mounting a deterrent assembly to the door hanger, comprising selecting a suitable position for the deterrent assembly by selecting a suitable mounting position within the deterrent-assembly-mounting opening, and fixedly mounting the deterrent assembly to the door hanger at the selected position, optionally by mounting through both the first and second deterrent-assembly-mounting openings.

In some examples, the deterrent assembly further comprises a deterrent guard, arranged at a top of the deterrent assembly. The top of the deterrent assembly will be understood as the end which is highest along the direction perpendicular to the first/movement direction (e.g. the vertical direction). The deterrent guard may provide the protrusion which engages with the slot of the latch mechanism, as described above.

In some examples, the deterrent assembly (e.g. a mounting plate of the deterrent assembly) comprises at least two (optionally at least three) mounting holes (optionally pairs of mounting holes), spaced apart along a first/lateral spacing direction. This may be the same first/lateral direction referred to above (i.e. when the deterrent assembly is mounted the mounting holes are spaced apart along the first direction, parallel to the direction along which the first elongate opening extends). Thus, in some examples a (e.g. lateral) position of the deterrent assembly relative to the door hanger is adjustable by mounting the deterrent assembly using a selected mounting hole of the at least two mounting holes. It will be understood that at least two holes may be used for mounting simultaneously, thus more than one (e.g. a pair) of openings may be selected for mounting.

The deterrent assembly may comprise a (first) connection mechanism, having a first end mounted to a mounting hole of the deterrent assembly mounting plate, and a second end mounted to a deterrent-assembly-mounting opening of the door hanger. The deterrent assembly may further comprise a second connection mechanism, having a first end mounted to a mounting hole of the deterrent assembly mounting plate, and a second end mounted to a deterrent-assembly-mounting opening of the door hanger. The (or each) connection mechanism may be a swing arm, which enables upwards and downwards movement of the deterrent assembly together with associated lateral movement, as is known in the art. Thus, the respective mounting hole need not be aligned directly over the corresponding deterrent-assembly-mounting opening of the door hanger for mounting of the deterrent assembly (i.e. since they are offset by the connection mechanism).

In some examples, the deterrent assembly (e.g. a mounting plate of the deterrent assembly) further comprises at least two (optionally at least three) deterrent-stop-mounting holes (optionally pairs of mounting holes), for mounting a deterrent stop, the deterrent-stop-mounting holes spaced apart along a first/lateral spacing direction. Thus, in some examples a (e.g. lateral) position of the deterrent stop relative to the deterrent assembly (i.e. and therefore the door hanger) is adjustable by mounting the deterrent stop to the deterrent assembly using a selected mounting hole of the at least two deterrent-stop-mounting holes. These deterrent-stop-mounting holes may thus enable mounting of the deterrent stop in an appropriate position (e.g. relative to the connection mechanism(s)) based on the lateral position at which the deterrent assembly has been mounted to the door hanger. Each deterrent-stop-mounting hole may correspond to a mounting hole used to mount the deterrent assembly (e.g. connection mechanism(s)), such that when a mounting hole (or pair) for mounting the deterrent assembly is selected, a corresponding deterrent-stop-mounting hole is selected, which places the deterrent stop in an appropriate position. The connection mechanism (or one of the connection mechanisms) may be positioned to contact the deterrent stop during its movement moving the deterrent assembly downwards, and thereby prevent further downwards motion, in a known manner.

In some examples, the elevator door coupler system further comprises a coupling assembly e.g. fixedly mounted to the door hanger.

In some examples the coupling assembly comprises a first vane arranged to engage, in use, a (first) landing door roller of a landing door (of a building). In some examples, the first vane comprises a first at least two mounting holes (i.e. a first set of mounting holes), spaced apart along a spacing direction, so as to enable the first vane to be mounted at different positions along the spacing direction (i.e. relative to another part of the coupling assembly or to the door hanger). The spacing direction may be the first direction, e.g. the movement direction. Thus the first at least two mounting holes may be spaced apart along the first direction, optionally only along this direction, i.e. at the same height, but different lateral positions.

In some examples, the coupling assembly further comprises a second vane, arranged to engage, in use, a (second) landing door roller of a landing door (of a building). In some examples, the second vane comprises a second at least two mounting holes (i.e. a second set of mounting holes), spaced apart along the spacing direction, so as to enable the second vane to be mounted at different positions along the spacing direction. Thus, the respective first and second at least two mounting holes may enable the first vane and the second vane to be mounted different distances apart along the spacing direction (e.g. for the first and second vanes to be mounted with different lateral separations).

The first set of mounting holes and/or the second set of mounting holes may comprise at least three mounting holes. The first set of mounting holes and/or the second set of mounting holes may comprise a first sub-set of mounting holes at a first height (i.e. a distance along a (second) direction perpendicular to the first direction) and a second sub-set of mounting holes at a second, different height. This may enable mounting of the first/second vane at two different mounting points, improving mounting stability. Two of the holes of the first and/or the second set may be partially overlapping.

In some examples, the method further comprises mounting a first vane and/or a second vane to the door hanger (i.e. directly or indirectly via one or more intermediate components). Mounting the first vane and/or the second vane may comprise selecting a suitable (e.g. lateral) position for the first vane and/or the second vane relative to the door hanger by selecting a suitable one of the first at least two holes and/or the second at least two holes for mounting the first vane and/or the second vane (respectively) and fixedly mounting the first vane and/or the second vane to the door hanger at the selected position(s). Thus, the method may include selecting an appropriate separation distance (along the separation/first direction) between the first and second vanes, and mounting them accordingly.

In some examples, the coupling assembly further comprises a connection mechanism connected between the first vane and the second vane, the connection mechanism arranged, in use, to actuate the first vane and/or the second vane to vary a separation distance between the first vane and the second vane e.g. along the separation/first direction. The connection mechanism may be arranged, in use, to increase a separation distance between the first vane and the second vane (i.e. due to being acted on by a door drive system) and thereby cause the vanes to engage with respective landing door rollers.

In some examples, the first vane and/or the second vane may be mounted to the connection mechanism, e.g. via the first set of holes and/second set of holes. The connection mechanism may be arranged to pivot about a fixed mounting point in response to force applied by the door drive system. The fixed mounting point(s) may be the point(s) at which the coupling assembly is fixed to the door hanger through the first (and optionally second) elongate opening(s).

In some examples, the coupling assembly further comprises a coupling plate, wherein the connection mechanism is mounted to the coupling plate and the coupling plate is mounted to the door hanger. This advantageously provides easier assembly since the vanes and/or the connection mechanism may be mounted to the coupling plate which is then mounted to the door hanger. Thus, components may be mounted in their desired configuration to the coupling plate, and this coupling plate may then be mounted at a desired location, based on the positions enabled by one or more elongate openings of the door hanger. The coupling plate may also provide further functions, such as accommodating a latch used for the door opening/closing mechanism.

In some examples, the coupling assembly comprises a coupling arm wherein a first end of the coupling arm is coupled, in use, to a drive belt. A second end of the coupling arm may be coupled to a further component of the coupling assembly, e.g. to the vanes, optionally indirectly via the connection mechanism. The second end may thus be coupled to the connection mechanism. This coupling arm allows other parts of the coupling assembly (e.g. the connection mechanism, and the vanes to which they are connected) to be spaced at a variable distance from the drive belt of the door drive system, i.e. to be moved further away than was possible in prior art systems. Since the coupling arm may be positioned at variable angles the distance of the other components from the belt may be varied both in the height direction and in the lateral direction.

It will be understood that the coupling arm may be coupled to the drive belt indirectly. In some examples, the coupling assembly further comprises a belt anchor, for attachment to a drive belt of a door drive mechanism. The belt anchor may be clamped around the drive belt. The coupling arm may be coupled (directly) to the belt anchor. The deterrent guard, described above, may be arranged to cover the belt anchor, i.e. to surround it on one or more sides.

It will be appreciated that the disclosure further extends to an elevator car, comprising an elevator car door, and the elevator door coupler system described herein above, wherein the elevator door coupler system is connected to the elevator car door. The method may likewise comprise connecting the door hanger to the elevator car door.

The disclosure further extends to a building comprising an elevator installation, the elevator installation comprising an elevator car as described above, and the building further comprising at least two landings, each landing comprising a respective set of landing doors, wherein each set of landing doors comprises a respective set of landing door rollers, wherein the coupling assembly described above (optionally the first and second vane) are arranged, in use, to engage with the landing door rollers.

It will be appreciated that the method may comprise any of the features described above in the context of the door coupler system (e.g. it may comprise the step of forming or providing such features, or assembling together mentioned components). Likewise, the door coupler system may according to the disclosure may comprise any of the features described in reference to the method.

### BRIEF DESCRIPTION OF THE DRAWINGS

Certain preferred examples of this disclosure will now be described, by way of example only, with reference to the accompanying drawings, in which:

FIG. 1 shows a schematic illustration of an elevator system that may employ various example elevator door coupler systems of the present disclosure;

FIG. 2 is a perspective view showing certain components of an elevator car including an elevator door coupler system according to a first example of the present disclosure;

FIG. 3 is a front view showing the components of FIG. 2, apart from the elevator car door panels;

FIG. 4 is an exploded view of the elevator door coupler system of FIGS. 2 and 3;

FIG. 5 is a front view of the hanger of the elevator door coupler system of FIGS. 2 and 3;

FIG. 6 is a side view of the hanger of FIG. 5;

FIG. 7 is a front view of the elevator door coupler system of FIGS. 2 and 3;

FIG. 8 is a front view of an elevator door coupler system according to a second example of the present disclosure;

FIG. 9 is a front view of an elevator door coupler system according to a second example of the present disclosure;

FIGS. 10 and 11 are perspective views from the opposite perspective to FIG. 2, showing certain components of the elevator door coupler system; and

FIG. 12 is a perspective view from behind showing certain components of the door hanger and the deterrent assembly.

### DETAILED DESCRIPTION OF THE INVENTION

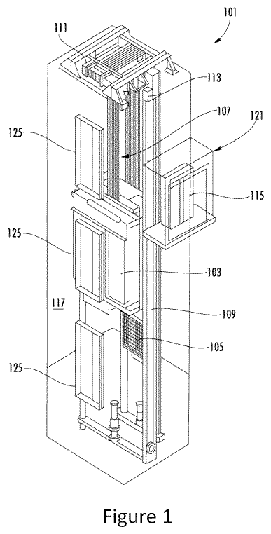

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. Although shown and described with a roping system including a tension member 107, elevator systems that employ other methods and mechanisms of moving an elevator car within an elevator hoistway may employ examples of the present disclosure.

The machine 111 is configured to control movement between the elevator car 103 and the counterweight 105. The controller 115 is located, as shown, in a controller room 121 of the elevator hoistway 117 and is configured to control the operation of the elevator system 101, and particularly the elevator car 103. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one example, the controller may be located remotely or in the cloud.

Each landing 125 includes a set of landing doors. The landing doors do not have their own motor to drive opening and closing of the landing doors. Instead, the elevator car 103 is provided with a door motor, which drives the elevator car doors to open and close, and an elevator door coupler system, which engages with the landing doors when the elevator car 103 is located at the corresponding landing, so that the landing doors open or close together with the elevator car doors.

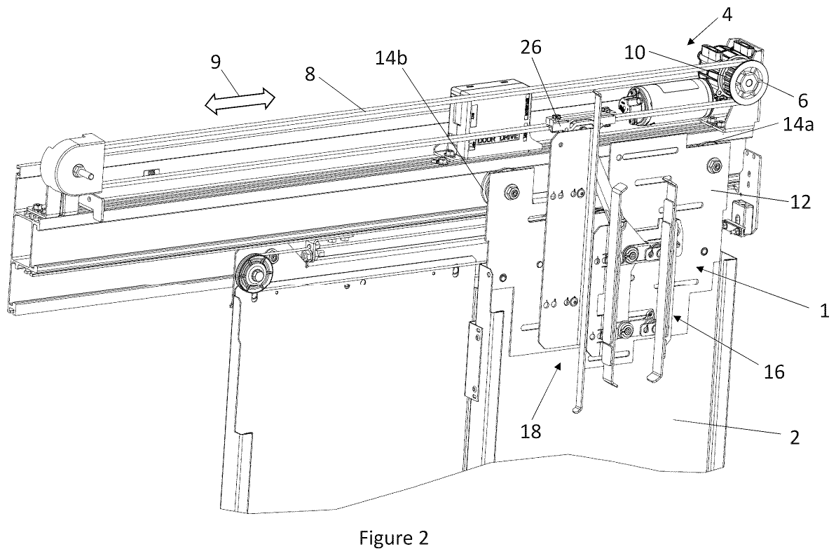

An example elevator door coupler system 1 according to the present disclosure is described in greater detail below with reference to FIGS. 2-7.

FIG. 2 is a perspective view showing certain components of an elevator car 103, including an elevator car door 2, a door drive system 4 and an elevator door coupler system 1.

The door drive system 4 includes a motor 6 and a drive belt 8. When actuation of the elevator car door is desired, the motor 6 is driven to rotate. This causes rotation of a ridged outer surface 10 of the motor 6, which engages with the drive belt 8 via friction, and it therefore drives the belt 8 to move (where the direction of movement depends on the direction in which the motor is driven). As is described further below, movement of the drive belt 8 drives motion of the elevator car door 2 along a movement direction 9, and also a set of landing doors if they are suitably engaged via the elevator door coupler system 1. The elevator car 103 may include a single elevator car door 2, which is driven directly by the door drive system 4, or it may also include a second door (i.e. both of which open symmetrically away from each other). The second elevator car door may have its own, separate door drive system, or it may be suitably connected to the first door drive system or the first elevator car door, such that both car doors open together and close together. For clarity, only a single door is shown and described here but it will be understood that the disclosure is not limited in this regard.

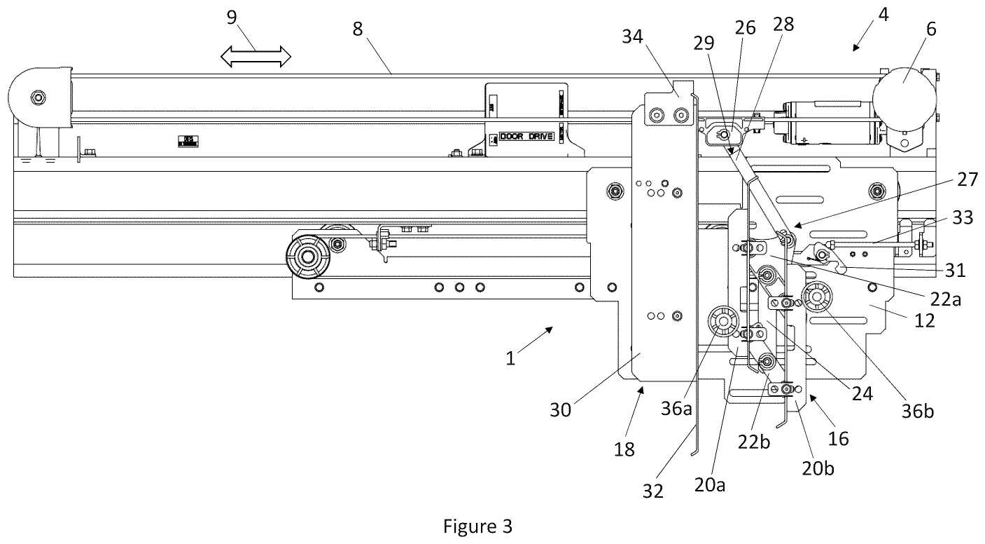

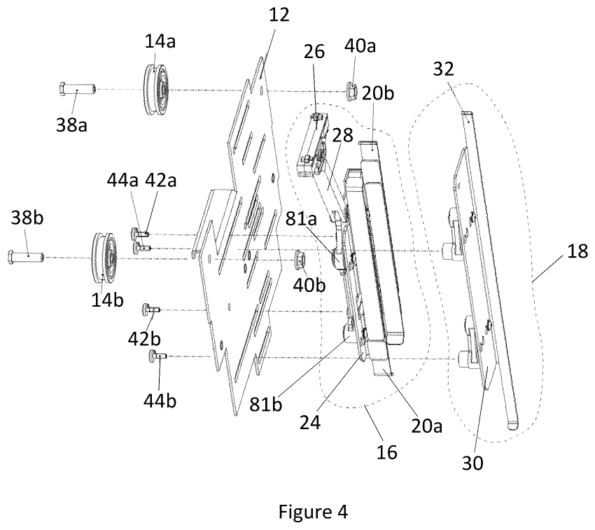

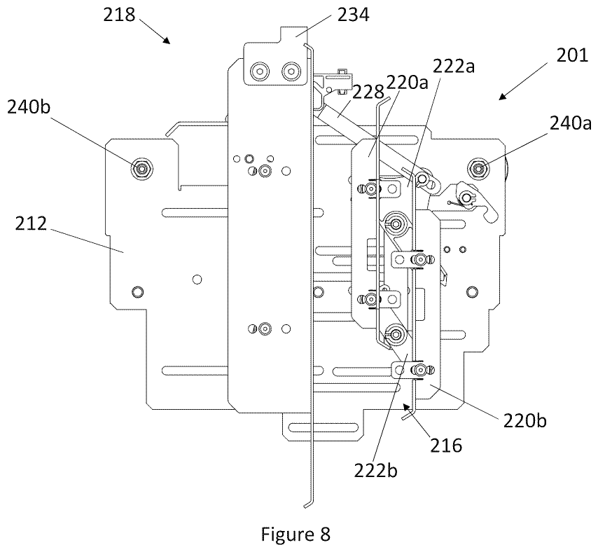

The elevator door coupler system 1 is seen from a front view in FIGS. 3 and 7, and in an exploded view in FIG. 4. As can be seen, the elevator door coupler system 1 includes a door hanger 12, and two rollers 14a, 14b. The rollers 14a, 14b are attached to the door hanger 12 such that the door hanger 12 is able to move back and forth, rolling on the rollers 14a, 14b.

The elevator door coupler system 1 further includes a coupling assembly 16, and a deterrent assembly 18.

The coupling assembly 16 includes a first vane 20a and a second vane 20b (which may also be referred to as cams). The coupling assembly 16 also includes a connection mechanism which in this example includes a first pivot arm 22a and a second pivot arm 22b. Each pivot arm 22a, 22b is connected to both the first vane 20a and the second vane 20b.

The pivot arms 22a, 22b are both connected to a coupling plate 24, which may also be referred to as a mounting plate. The coupling plate 24 is mounted to the door hanger 12, as described further below.

The coupling assembly 16 is also connected to the drive belt 8, in order that the drive belt 8 may drive motion of the elevator car door 2 and of the landing doors to which the coupling assembly 16 couples. In particular, the coupling assembly 16 includes a belt anchor 26 which is attached directly to the belt 8. It further includes a coupling arm 28 which is connected at a first end 27 to the connection mechanism-in particular to the first pivot arm 22a, and is connected at a second (opposite) end 29 to the belt anchor 26. The coupling arm 28 is a rigid connecting arm. It allows more versatility in the placement of the rest of the coupling assembly 16 since it removes a need for the connection mechanism to be directly connected to the belt anchor or the belt.

Operation of the elevator door coupler system 1 during opening and closing of a set of elevator landing doors will now be described with reference to FIGS. 2-7.

Door opening is started by activating the motor 6. This drives the motor 6 to rotate the belt 8. For door opening in this example the belt 8 rotates clockwise with reference to the view of FIG. 3, driving the belt anchor 26 to the left.

Movement of the belt anchor 26 to the left applies a force to the rigid coupling arm 28, which is transferred to the first pivot arm 22a. This causes the first pivot arm 22a to rotate counter-clockwise, and therefore moves the first vane 20a downwards and the second vane 20b upwards, whilst moving them respectively apart from each other. This movement also causes anti-clockwise rotation of the second pivot arm 22b about its mounting point (since it is also connected to both vanes 20a, 20b).

The movement of the vanes 20a, 20b apart from each other causes them to engage with landing door rollers 36a, 36b seen in FIG. 3, assuming that the elevator car has been stopped at a suitable height relative to a set of landing doors.

Then, once the vanes 20a, 20b have rotated to be level with each other, so the lower edge of the first pivot arm 22a is aligned horizontally, movement of the belt anchor 26 further to the left causes a catch 31 to be released. The catch 31 once released rotates and engages with a protrusion of the first pivot arm 22a (not visible), to hold the vanes 20a, 20b in their relative configuration.

As the belt anchor 26 moves even further to the left, the first pivot arm 22a and therefore the vanes 20a, 20b are carried with it to the left. This moves the landing door rollers 36a, 36b to the left, opening the landing doors. Since the elevator car door 2 is connected to the door hanger 12, which in turn is connected to the coupling assembly 16, this motion also opens the elevator car door 2.

For door closing this process is essentially just reversed, driving the belt anchor 26 to the right. The catch 31 keeps the vanes 20a, 20b in their aligned position, ensuring the motion of the belt anchor 26 is translated to sideways motion of the door, until such point as the door is fully closed. At this point a protrusion 33 engages an upper edge of the catch 31, rotating it out of its engaged position, to release the pivot arm 22a, and allow the pivot arm 22a to rotate clockwise, moving the vanes 20a, 20b closer together, so that the landing door rollers 36a, 36b are released. Although not shown a biasing spring may be provided connecting between the first and second pivot arms 22a, 22b and biasing them to rotate clockwise, so that they return to the position illustrated in FIG. 3 once the catch 31 is released.

The elevator door coupler system 1 further includes a deterrent assembly 18. The deterrent assembly 18 includes a deterrent mounting plate 30, via which the deterrent assembly 18 is mounted to the door hanger 12. It also includes a deterrent blade 32, extending forwards (i.e. out of the page) from the deterrent mounting plate 30, from the view of FIG. 3, and a deterrent guard 34 positioned at the top of the deterrent assembly 18 (specifically the deterrent mounting plate 30), and arranged to cover the belt anchor 26 as seen in FIG. 3.

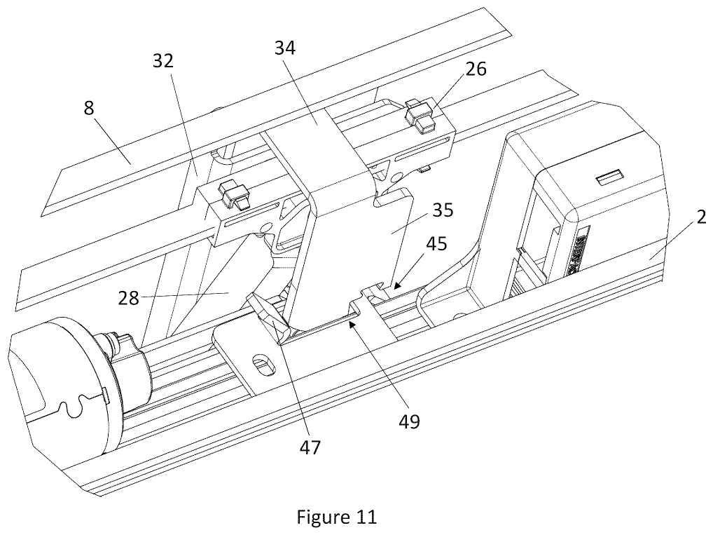

The operation of the deterrent assembly 18 is explained briefly with reference to FIGS. 10 and 11. FIGS. 10 and 11 are perspective views from above the deterrent assembly, in the opposite direction to the perspective of FIG. 2.

The top edge of the elevator car door panel 2 includes a latch 45. The latch 45 includes a ramped portion 47 and a slot 49. The deterrent guard 34 includes a protrusion 35 (which may also be referred to as a hook).

FIG. 10 shows the position of the deterrent assembly 18 when the elevator car door is closed. In this position the protrusion 35 rests on the ramped portion 47, holding the deterrent assembly 18 in an upwards position (i.e. upwards relative to the elevator car door panel 2).

When the elevator door coupler system 1 is correctly engaged with landing doors, landing rollers 36a, 36b are pressed outwards by the vanes 20a, 20b, as described above. This causes one of these rollers 36a (i.e. the left one in the view of FIGS. 2 and 3) to be pressed into contact with the deterrent blade 32 of the deterrent assembly 18. This pressure and friction due to contact with the landing door roller 36a holds the deterrent assembly 18 in the upwards position, keeping the protrusion 35 from falling into the slot 49 as the door opens (as the deterrent assembly 18 moves to the right from the perspective of FIG. 10). It will be appreciated that this may be achieved by controlling the way in which the deterrent assembly 18 is arranged to move, i.e. such that it must move inwards towards the coupler assembly in order to also drop in height.

In contrast, if no landing door roller 36a contacts the deterrent blade 32, the deterrent assembly 18 will drop as it moves off the ramped portion 47 due to being moved (to the right in FIG. 10) as door opening is started. As a result, the protrusion 35 will drop into the slot 49, as seen in FIG. 11, and thereby prevent further movement of the deterrent assembly 18, and therefore of the whole elevator door coupler system 1, in the door opening direction.

Turning to the exploded view of FIG. 4 it can be seen how the parts of the elevator door coupler system 1 are assembled.

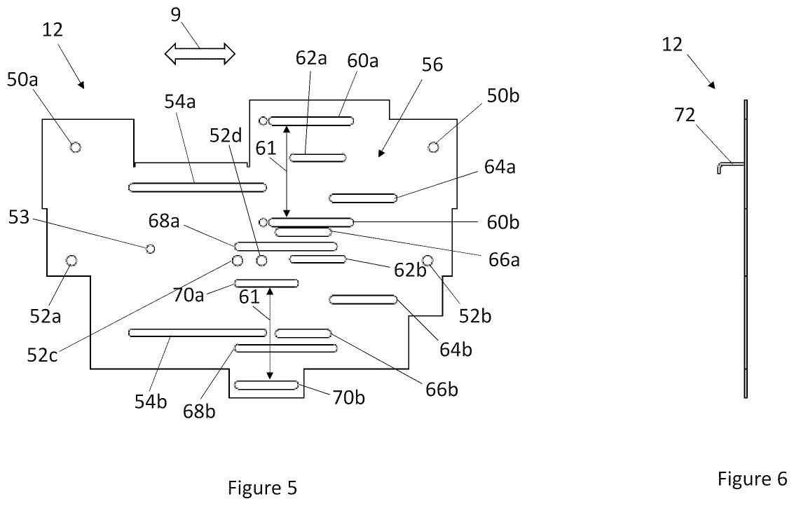

The two rollers 14a, 14b are mounted to the door hanger 12 via respective roller screws or bolts 38a, 38b, onto which a corresponding roller nut 40a, 40b is fastened on the opposite side of the door hanger 12. The roller screws 38a, 38b pass through corresponding roller mounting holes 50a, 50b seen in FIG. 5 in the upper section of the door hanger 12, towards each outer edge. Arranged directly below these roller mounting holes 50a, 50b are a first pair of outer openings which provide elevator door mounting openings 52a, 52b, for attaching the door hanger 12 to the elevator car door 2 (i.e. via screws passing through these holes), as seen in FIG. 2. Arranged at the centre of the hanger 12 are an inner pair of openings 52c, 52d, which provide a further pair of openings also for attaching the elevator car door 2 to the door hanger 12.

The door hanger 12 also contains a further opening 53 arranged in the left-hand part of the door hanger 12, at a central height. This further opening 53 is for accommodating a fixing which provides a fixed point of connection between a fast hanger and a slow hanger in the case where the elevator car door 2 is telescopic.

The coupling assembly 16 (in particular the coupling plate 24) is mounted to the door hanger 12 via two coupling screws 42a, 42b. The deterrent assembly 18 (in particular the mounting plate 30) is mounted to the door hanger 12 via two deterrent screws 44a, 44b. These screws may be positioned in various places, in order to mount the coupling assembly 16 at different positions, as explained further with reference to FIG. 5.

The door hanger 12 contains a number of elongate openings, which allow the coupling assembly 16 and the deterrent assembly 18 to be mounted to the door hanger 12 in a variety of different positions, allowing the elevator door coupler system 1 to adapt to be compatible with a variety of landing doors with different landing door roller positions.

The door hanger includes a first pair of deterrent-assembly-mounting-openings 54a, 54b, each of which is an elongate opening (i.e. slot) extending horizontally, along the movement direction 9. The deterrent screws 44a, 44b can of course be passed through the opening at any lateral position, meaning that the mounting point for the deterrent assembly 18 may be any point along their lateral span. Since the openings in the deterrent mounting plate 30 are vertically one above the other (i.e. aligned relative to the movement direction) the lateral position for mounting will be the same in both of the openings 54a, 54b. By using these elongate deterrent-assembly-mounting-openings 54a, 54b the position of the deterrent assembly 18 to the left or right (according to the view of FIG. 7) is adjustable. Allowing it to be positioned in a way which is compatible with a wide range of landing doors.

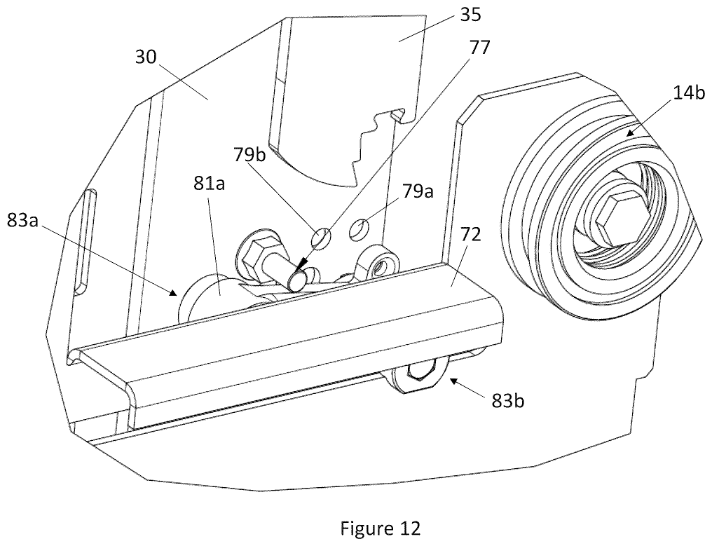

Furthermore, as seen in FIG. 7, the deterrent assembly mounting plate 30 includes three pairs of mounting holes 71a, 71b, 73a, 73b, 75a, 75b, each at different lateral positions across the deterrent assembly mounting plate 30. All holes of all three pairs are at the same heights. This enables even more precise adjustment of the position of the deterrent assembly, by selection of which pair of holes 71a, 71b, 73a, 73b, 75a, 75b, are used for mounting the deterrent assembly 18. In this example, a connection mechanism 81a (partially visible in FIG. 4, and seen in FIG. 12) is connected at a first end 83a through one of the mounting holes 71a, 73a, 75a, and at a second end 83b through the deterrent-assembly-mounting-opening 54a. Similarly, a second connection mechanism 81b is connected at a first end through one of the lower mounting holes 71b, 73b, 75b (the hole corresponding to the one used to mount the upper connection mechanism) and at a second end through the lower deterrent-assembly-mounting-opening 54b. These connection mechanisms 81a, 81b operate in a known manner to provide a swing-arm motion which allows the deterrent assembly 18 to swing downwards and laterally inwards (towards the coupling assembly 16) or to move upwards and laterally outwards (away from the coupling assembly 16).

FIG. 12 shows a similar perspective to FIGS. 10 and 11, i.e. also from behind the door hanger, but this time from a lower angle.

A deterrent stop 77 (seen in FIGS. 7 and 12) is provided to limit the range of motion of the deterrent assembly 18, by contacting the upper connection mechanism 81a during its motion, as seen in FIG. 12. Three mounting holes 79a, 79b, 79c are provided for mounting the deterrent stop 77 through the deterrent assembly mounting plate 30 in different lateral positions.

The three deterrent-stop-mounting holes 79a, 79b, 79c allow the deterrent stop to be mounted at different lateral positions relative to the deterrent assembly mounting plate 30. This allows the deterrent stop 77 to be mounted at an appropriate lateral position relative to the connection mechanisms 81a, 81b. Thus, depending on which pair of mounting holes 71a, 71b, 73a, 73b, 75a, 75b is used for mounting the pair of connection mechanisms to the mounting plate 30, a corresponding deterrent-stop-mounting hole 79a, 79b, 79c is used for mounting the deterrent stop 77.

The door hanger 12 includes a set of openings 56 for mounting the coupling assembly 16. In this example, this set of openings 56 includes six pairs of elongate openings—a first pair of elongate openings 60a, 60b, a second pair of elongate openings 62a, 62b, a third pair of elongate openings 64a, 64b, a fourth pair of elongate openings 66a, 66b, a fifth pair of elongate openings 68a, 68b and a sixth set of elongate openings 70a, 70b.

As can be seen in FIG. 5, each pair of openings is vertically aligned one above the other, and has the same length. Thus, both openings of a pair allow the same lateral range of possible positions. Furthermore, the openings of each pair are separated by the same height difference 61. This corresponds to a separation between the two mounting holes of the coupling plate 24.

This set of pairs of openings 56 thus enables mounting of the coupling assembly 16 at six different heights corresponding to the relative heights of the six pairs of openings. It will be understood that it is irrelevant which point of reference is used to define the height of each pair of openings. For example, the height of a pair of openings may be defined as the height of the upper elongate opening, the height of the lower elongate opening, or the height of a point halfway between the openings. Thus, by selecting a pair of openings from the set of pairs, a height for mounting the coupling assembly is chosen. This stage may be completed during manufacture, with the coupling screws 42a, 42b being inserted through two selected openings.

Then, for each pair of openings 60a, 60b, 62a, 62b, 64a, 64b, 66a, 66b, 68a, 68b, 70a, 70b, a range of lateral mounting positions is possible, anywhere along the elongate length of the openings. This lateral positioning may be selected during installation by fully tightening the coupling screws 42a, 42b when the coupling assembly is at the desired position. The mounting position of the coupling assembly 16 is therefore highly versatile.

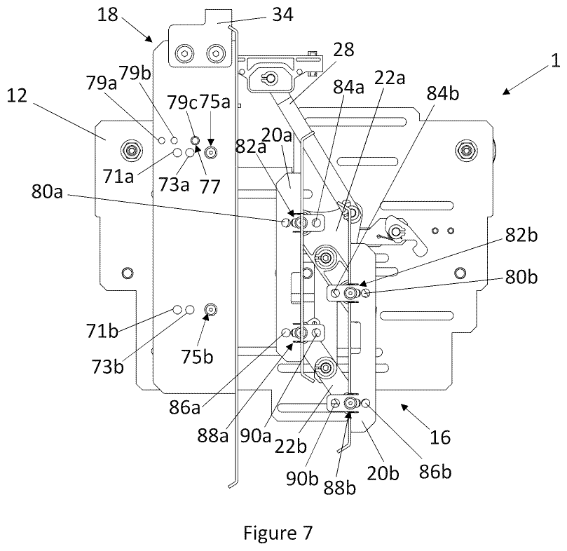

As seen in the side view of the door hanger 12 in FIG. 6, a hook portion 72 extends from the door hanger 12 on the opposite side to the coupling assembly 16 (i.e. towards the elevator car door 2, rearwards from the door hanger 12). The function of this hook portion 72 is to retain the door hanger 12 and the panels of the elevator car door 2 in position in the event of a violent impact on them, in order to prevent them from falling into the hoistway.

To allow further flexibility in the elevator door coupler system 1 the vanes 20a, 20b are also provided with several mounting holes, through which the vanes 20a, 20b are mounted to each of the pivot arms 22a, 22b. This allows the vanes 20a, 20b to be mounted with different (horizontal) separation distances between them.

These mounting holes are seen in FIG. 7. The first vane 20a includes a first set of three mounting holes 80a, 82a, 84a all in a line (i.e. at the same height), all at different lateral positions, and a second set of three mounting holes 86a, 88a, 90a, located at a different (lower) height, and again all located at different lateral positions. Each of the holes in the first set is vertically aligned above a corresponding hole of the second set of holes.

Similarly, the second vane 20b includes a first set of three mounting holes 80b, 82b, 84b all in a line (i.e. at the same height), all at different lateral positions, and a second set of three mounting holes 86b, 88b, 90b, located at a different (lower) height, and again all located at different lateral positions. Each of the first set is vertically aligned above a corresponding hole of the second set of holes.

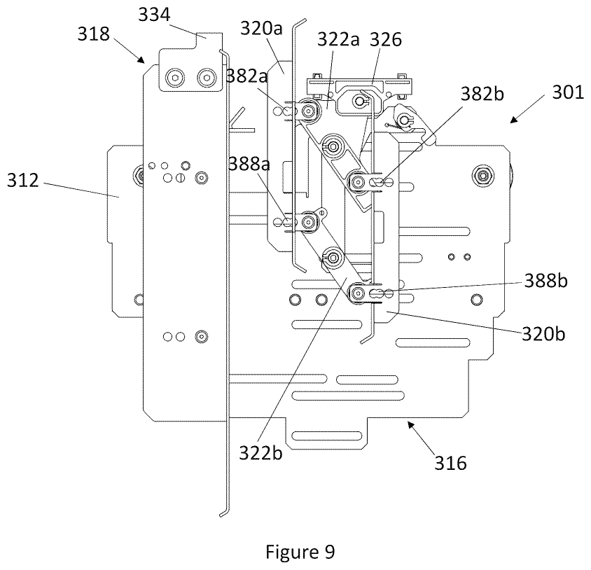

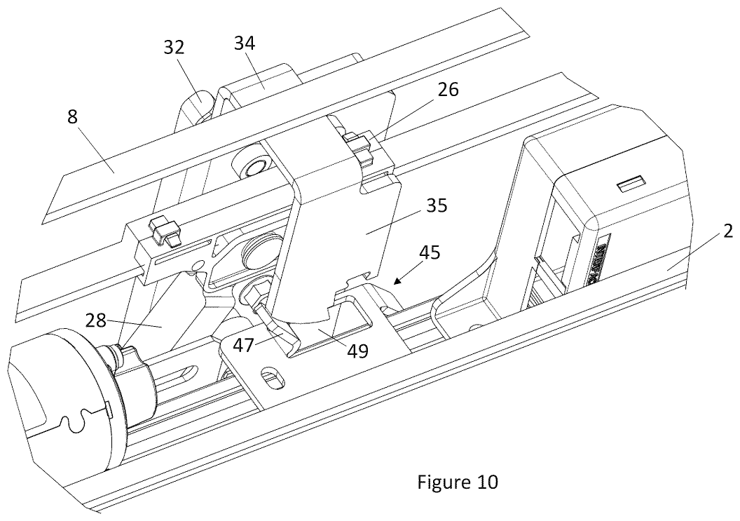

To illustrate the versatility provided by elevator door coupler system 1 described herein, three possible arrangements of the elevator door coupler system 1 are shown, in FIGS. 7, 8 and 9. In each of these examples the components are all the same (i.e. the door hanger 12 and the vanes 20a, 20b are the same) but there are variations in the mounting position of various components. FIG. 7 shows the components in the same mounting locations as in the example of FIGS. 2-6, therefore the same reference numerals have been used as in these Figures. For the other two examples, of FIGS. 8 and 9 respectively, different reference numerals have been used for clarity. In FIG. 8, corresponding reference numerals are used as in the first example of FIGS. 2-7, with their value increased by 200. In FIG. 9, corresponding reference numerals are used as in the first example of FIGS. 2-7, with their value increased by 300.

In the example of FIG. 7, the coupling assembly 16 is mounted to the door hanger through the fifth pair of elongate openings 68a, 68b as shown in FIG. 5. The deterrent is mounted in the first pair of deterrent-assembly-mounting-openings 54a, 54b at a position towards their left-hand end, but not at the extreme left-hand position. The vanes 20a, 20b are mounted to the pivot arms 22a, 22b through their central mounting holes 82a, 82b, 88a, 88b. It can be seen that these central mounting holes 82a, 82b, 88a, 88b have the form of two overlapping round holes, and that in this example the vanes 20a, 20b are mounted through the inner part of the holes. This overlapping arrangement allows the holes to be closer together and therefore for the two available adjacent lateral positions to be closer together.

In the example of FIG. 8, the deterrent assembly 218 is now mounted far to the right-hand side of the first pair of deterrent-assembly-mounting-openings 54a, 54b, although not at the extreme right position. The coupling assembly 216 is mounted in the third pair of elongate openings, which are labelled as 64a, 64b in the view of FIG. 5, and is thus mounted higher up than in the example of FIG. 7. The vanes 220a, 220b are again mounted to the pivot arms 222a, 222b through their central mounting holes but in this case through the outer part of these central holes. The vanes 220a, 220b are therefore slightly closer together than in the example of FIG. 7.

In the example of FIG. 9, the deterrent assembly 18 is now mounted in the extreme left-hand position, i.e. at the very left-hand end of the deterrent-assembly-mounting-openings 54a, 54b. The coupling assembly 316 is mounted at the highest possible position, in the first pair of slots 60a, 60b. Since the coupling assembly 316 is mounted so high up, in this example the coupling arm is omitted and instead the belt anchor 326 is connected directly to the first pivot arm 322a.

In this example the vanes 320a, 320b are mounted to the first and second pivot arms 322a, 322b through the innermost openings (corresponding to the innermost openings 84a, 84b, 90a, 90b shown in FIG. 7). As a result, the vanes 320a, 320b are spaced significantly further apart than in the examples of FIGS. 7 and 8. The central openings 382a, 382b, 388a, 388b of the vanes 320a, 320b are more clearly visible in this Figure, since the innermost mounting holes are used. It can be clearly seen that they have the form of two overlapping circular holes, as described above.

It will be appreciated by those skilled in the art that the disclosure has been illustrated by describing one or more specific aspects thereof, but is not limited to these aspects; many variations and modifications are possible, within the scope of the accompanying claims.

What is claimed is:

1. An elevator door coupler system (1; 201; 301) comprising:
a door hanger (12; 212; 312), for connection to an elevator car door (2); and
at least one roller (14a, 14b), mounted to the door hanger (12; 212; 312);
wherein the door hanger (12; 212; 312) comprises a first elongate opening (54a, 54b, 60a, 60b, 62a, 62b, 64a, 64b, 66a, 66b, 68a, 68b, 70a, 70b) for fixedly mounting a coupling assembly (16; 216; 316) arranged to engage a landing door so as to actuate movement of the landing door together with movement of the elevator car door (2), such that a position of the coupling assembly (16; 216; 316) relative to the door hanger (12; 212; 312) is adjustable by mounting the coupling assembly (16; 216; 316) at a different position within the first elongate opening (54a, 54b, 60a, 60b, 62a, 62b, 64a, 64b, 66a, 66b, 68a, 68b, 70a, 70b).

2. The elevator door coupler system (1; 201; 301) of claim 1, wherein the at least one roller enables movement of the door hanger (12; 212; 312) along a movement direction (9), so as to enable, in use, movement of the elevator car door (2) parallel to the movement direction (9), and wherein the first elongate opening (54a, 54b, 60a, 60b, 62a, 62b, 64a, 64b, 66a, 66b, 68a, 68b, 70a, 70b) is elongate along a direction parallel to the movement direction.

3. The elevator door coupler system (1; 201; 301) of claim 1, wherein the first elongate opening (54a, 54b, 60a, 60b, 62a, 62b, 64a, 64b, 66a, 66b, 68a, 68b, 70a, 70b) has a length of at least 5 cm.

4. The elevator door coupler system (1; 201; 301) of claim 1, wherein the first elongate opening (54a, 54b, 60a, 60b, 62a, 62b, 64a, 64b, 66a, 66b, 68a, 68b, 70a, 70b) is elongate a first direction, and wherein the door hanger (12; 212; 312) further comprises a second elongate opening (54a, 54b, 60a, 60b, 62a, 62b, 64a, 64b, 66a, 66b, 68a, 68b, 70a, 70b), spaced apart from the first elongate opening along a direction perpendicular to the first direction (9).

5. The elevator door coupler system (1; 201; 301) of claim 4, wherein the first elongate opening (54a, 54b, 60a, 60b, 62a, 62b, 64a, 64b, 66a, 66b, 68a, 68b, 70a, 70b) and the second elongate opening span different distance ranges along the first direction.

6. The elevator door coupler system (1; 201; 301) of claim 4, wherein the first elongate opening (54a, 54b, 60a, 60b, 62a, 62b, 64a, 64b, 66a, 66b, 68a, 68b, 70a, 70b) and the second elongate opening span the same distance range along the first direction, and wherein the coupling assembly (16; 216; 316) is arranged to be fixedly mounted to the door hanger (12; 212; 312) through both the first elongate opening and the second elongate opening simultaneously.

7. The elevator door coupler system (1; 201; 301) of claim 1, further comprising a deterrent assembly (18; 218; 318) for preventing, in use, the opening of the elevator car door (2) when the coupling assembly (16; 216; 316) is not engaged with the landing door, and wherein the door hanger (12; 212; 312) further comprises a deterrent-assembly-mounting opening (54a, 54b), for fixedly mounting the deterrent assembly (18; 218; 318) to the door hanger (12; 212; 312), wherein the deterrent-assembly-mounting opening (54a, 54b) is elongate, such that a position of the deterrent assembly (18; 218; 318) relative to the door hanger (12; 212; 312) is adjustable by mounting the deterrent assembly (18; 218; 318) at a different position within the deterrent-assembly-mounting opening (54a, 54b).

8. The elevator door coupler system (1; 201; 301) of claim 7, wherein the deterrent assembly (18; 218; 318) comprises at least two mounting holes, spaced apart along the first direction, such that a position of the deterrent assembly (18; 218; 318) relative to the door hanger (12; 212; 312) is adjustable by mounting the deterrent assembly (18; 218; 318) using a selected mounting hole of the at least two mounting holes.

9. The elevator door coupler system (1; 201; 301) of claim 1, further comprising a coupling assembly (16; 216; 316).

10. The elevator door coupler system (1; 201; 301) of claim 9, wherein the coupling assembly (16; 216; 316) comprises a first vane (20a; 220a; 320a) and a second vane (20b; 220a; 320a), arranged to engage, in use, respective landing door rollers of a landing door.

11. The elevator door coupler system (1; 201; 301) of claim 10, wherein the first vane (20a; 220a; 320a) comprises a first at least two mounting holes (80a, 82a, 84a), spaced apart along a spacing direction and wherein the second vane (20b; 220a; 320a) comprises a second at least two mounting holes, spaced apart along the spacing direction, so as to enable the first vane (20a; 220a; 320a) and the second vane (20b; 220b; 320b) to be mounted different distances apart along the spacing direction.

12. The elevator door coupler system (1; 201; 301) of claim 10, wherein the coupling assembly (16; 216; 316) further comprises a connection mechanism (22a, 22b; 222a, 222b; 322a, 322b) connected between the first vane (20a; 220a; 320a) and the second vane (20b; 220a; 320a), the connection mechanism arranged, in use, to actuate the first vane (20a; 220a; 320a) and/or the second vane (20b; 220a; 320a) to vary a separation distance between the first vane (20a; 220a; 320a) and the second vane (20b; 220a; 320a).

13. The elevator door coupler system (1; 201; 301) of claim 12, wherein the coupling assembly (16; 216; 316) further comprises a coupling plate (24; 224; 324) and wherein the connection mechanism (22a, 22b; 222a, 222b; 322a, 322b) is mounted to the coupling plate (24; 224; 324) and the coupling plate (24; 224; 324) is mounted to the door hanger (16; 216; 316).

14. The elevator door coupler system (1; 201; 301) of claim 9, wherein the coupling assembly (16; 216; 316) comprises a coupling arm (28; 228), wherein a first end of the coupling arm (28; 228) is coupled, in use, to a drive belt (8).

15. A method of installing an elevator door coupler system into an elevator system, the method comprising:
mounting at least one roller (12; 212; 312) to a door hanger (12; 212; 312), the door hanger (12; 212; 312) suitable for connection to an elevator car door (2); and
mounting a coupling assembly (16; 216; 316) to the door hanger (12; 212; 312), the mounting comprising selecting a suitable position for the coupling assembly (16; 216; 316) relative to the door hanger (12; 212; 312) by selecting a suitable mounting position within a first elongate opening of the door hanger (12; 212; 312) and fixedly mounting the coupling assembly (16; 216; 316) to the door hanger (12; 212; 312) at the selected position.
